(19) United States
(12) Patent Application Publication
(10) Pub. No.: US 2012/0086207 A1
(43) Pub. Date: Apr. 12, 2012

(54) Simplified Paddlewheel Energy Device

(76) Inventor: Dennis John Gray, Spring, TX (US)

(21) Appl. No.: 12/900,422

(22) Filed: Oct. 7, 2010

(51) Int. Cl. F03B 13/00

(52) U.S. Cl. 290/54

(57) ABSTRACT

This invention is a device for transforming the energy of flowing water into useable energy. The device comprises one or more paddlewheels, and one or more generators mounted on a paddlewheel, one or more mooring lines, and a means by which to hold the device in position relative to the moving water. A subsea cable may be included to transmit the electrical energy generated by the device to shore.

### CROSS-REFERENCES TO MOST RELATED APPLICATIONS

| Patent or | |
|---|---|
| Application # | Title |
| 7,094,017 | Vertical Shaft Driving Device for Vertical Wind Mills |
| 7,063,579 | Method and Apparatus for Retrieving Energy From a |
| | Flowing Stream |
| 6,759,757 | Method and Apparatus for Converting Tidal Power into |
| | Electrical Energy |
| 6,755,607 | Hydro-Energy Converter |
| 6,246,125 | Portable Wind and Hydro Electric Generating System |
| 5,420,463 | Fluid Driven Power System |
| 4,519,742 | Apparatus for Utilizing the Energy Present in Flowing |
| | Water |
| 4,239,976 | Floating Electric Generator Using the Driving Energy of |
| | Water |
| 4,392,061 | Apparatus for Utilizing the Energy of Wave Swells and |
| | Waves |
| 3,746,875 | Electrical Power Plant Driven by Ocean Waves and |
| | Tides |
| 7,378,750 | Tidal Flow Hydroelectric Turbine |
| 7,329,961 | Device for Deriving Energy From Moving Fluids |
| 7,242,107 | Water-based Wind-driven Power Generation Using |
| | Submerged Platform |
| 7,147,428 | Hydro Turbine |
| 20040195840 | Miniature Hydro Power Generation System |
| 20080101865 | Hydrodynamic Drive Train for Energy Converters That |
| | Use Ocean Currents |
| 20080088135 | Electric Power Generating Systems Using Ring Shaped |
| | Generators |
| 20080018113 | Wave Power Plant |
| 20070081861 | Wave Generator |
| 20060019553 | Method and Apparatus for Retrieving Energy From a |
| | Flowing Stream of Water |

### STATEMENT REGARDING FEDERALLY SPONSORED RESEARCH & DEVELOPMENT

Not Applicable. No others have rights to this patent. Dennis Gray is the sole inventor and the invention was not created under any federally sponsored programs.

### BACKGROUND OF THE INVENTION

Populations grow exponentially, world economies are expanding, demand for energy is escalating, global warming becomes more evident, and fossil fuels will eventually run out. Political tensions over hydrocarbons are high to say the least. The United States, and the rest of the world, needs solutions to these energy problems and they need them to be clean renewable solutions. The patentability of this particular invention is primarily due to that it is greatly simplified in comparison with any other paddlewheel type marine energy device. In short, it has far less elements which makes it far more cost-effective.

In the Atlantic Ocean off the Southeastern United States runs the Gulf Stream. Essentially, the Gulf Stream is a river of ocean water flowing with an average speed of approximately 4 mph. At its widest point, the Gulf Stream is almost as wide as Florida. This flow of ocean water carries as much energy as the entire world consumes 100 times over and it flows constantly 24 hrs a day 365 days a year. Similar currents run along the edges of all other continents. Ocean currents are not the only places where this invention can be used. Tidal regions and rivers provide thousands of additional locations.

Numerous companies have designed and built devices that convert the energy of flowing water into useable electricity but such devices have tended consist of traditional turbines. These “marine turbines” are very similar to wind turbines but they are designed to be used underwater. Marine turbines have rotating blades that slice through the water, and likewise slice at whales, manatees, dolphins, and other marine animals that may be swimming by. Note that by design these marine turbines are designed to have the blades moving with tip speeds that can be four to six times as fast as the flowing water. Blade impacts can not only injure marine animals but also break the blades of the device and render the marine turbine useless until it is repaired. When these traditional marine turbines are used in flowing rivers they are not only susceptible to damage by animal impacts but by debris such as tree branches that drift downstream. Solutions to these problems are virtually non-existent because screening the water flow ahead of such turbines ultimately blocks the energy they are trying to harness. Any screen would soon be clogged with seaweed and marine growth in a very short period of time anyway. A new approach was deemed necessary and the invention herein provides the solutions.

To be viable, a device that converts the energy of flowing water into useable energy must not harm marine life. The device must also be very strong and robust to survive punishing river and ocean environments. Traditional turbine blades must be hydrodynamically efficient and thus cannot be thick, strong, and robust as required. Traditional turbine blades are inherently flawed for the multiple tasks required of them. One must consider that both rpm (speed) and torque contribute to power output. Speed should be sacrificed if far more torque can be made available and the device becomes safe. Slicing turbine blades are designed for minimal drag, fastest speed, and this presents environmental hazards. Paddle turbines, on the other hand, can have orders of magnitude more surface area (more torque), rotate more slowly for maximum power output (max power when better fighting/resisting current flow), and they have no slicing blades.

Generating massive amounts of renewable energy is different than ship propulsion. Thus, the fact that mankind has moved away from using paddles in ship propulsion does not apply. The cost of a propeller has little impact to the long term cost-effectiveness of a ship's propulsion system. The cost of a “propeller” in a renewable energy device, on the other hand, has an enormous impact on the cost-effectiveness of the device due to its size. We acknowledge that a paddle can be as much as 25% less efficient than a typical turbine blade. Said another way, we recognize that a paddle may extract as little as 75% of the force that a turbine blade of similar area might extract. We fully accept this efficiency reduction, or an even greater efficiency reduction, because a paddle has a significant cost per unit area advantage. In short, massive sail areas on paddlewheels can be created at very low costs vs. thick turbine blades made of expensive materials.

To be reliable, a device that converts energy from flowing water cannot be complex. Sophisticated components should be avoided and all critical components must be well protected from the harsh wet conditions. An uncomplicated design will also ensure capital, operating, and maintenance costs associated with the device will be very low. When costs are low enough, the resulting cost per kilowatt hour can match that of fossil fuels. Paddle turbines, unlike marine turbine blades, are designed with maximum drag to extract the greatest amount of energy. Drag is a benefit. Paddles extract more power at somewhat slower speeds when they are best fighting or resisting the flow against them. Paddle turbines are safe at slow speeds. Since drag is beneficial the paddles can be scaled hundreds of times larger than marine turbine blades which allows them to extract orders of magnitude more energy. Better still, only a handful of components are required instead of arrays of devices as with marine turbines. Singular but large paddle turbines eliminate thousands of components, high maintenance costs, etc.

The invention herein converts energy from flowing water and can be scaled up to enormous size without requiring an array, or vast quantities, of such devices. As mentioned before, many devices in an array only results in excessive components. Spread out amongst the array, even simple components will be difficult to maintain if they are distributed out over several square miles of ocean bottom. The critical components of this invention are above water level, contained in one small space, and are readily accessible.

An ideal device would not be affected by hurricanes nor typhoons that might pass by. The middle portion of this invention's paddlewheel shaft can be flooded which allows the device to temporarily sink and hang from a spherical buoy until severe storms pass. Once a storm has passed the paddlewheel shaft can be pumped with air (water removed) and the device once again floats and operates on water surface. Note that even while temporarily submerged this invention can continue to produce electricity.

Upon review of all similar innovations, one will find that prior art has addressed only a few of the necessary requirements. Without addressing all of them, such a device cannot produce power both safely and cost-effectively. Particular features not found in prior inventions make this particular invention considerably more viable, practical, cost-effective, harmless to underwater environments, and able to survive severe storm conditions.

### BRIEF SUMMARY OF THE INVENTION

The purpose of this invention is to safely, efficiently, and cost-effectively transform the energy of moving water into useful electrical energy and do so with virtually no impact to underwater environments. The invention is cost-effective because unlike others it utilizes the absolute minimal components possible. This device permits animals such as dolphins, manatees and whales to safely swim directly through the invention unharmed unlike traditional marine. Just one of these devices can be scaled up to enormous size without creating an array of these devices. Even at enormous size this invention still contains the same low number of components that a small version of the device contains.

This invention, due to the remarkably low number of components and the selection of components that perform well in oceanic environments can be operated and maintained at extremely low costs. The design of this invention ensures that capital costs are very low and reliability is extremely high. The critical components in this invention are 100% protected from water contact which keeps maintenance costs negligible. Great care has been taken to ensure that installation costs associated with this invention are very low due to modular construction methods and the ability to tow a complete device to site. As a result of the unique features described herein, this invention produces energy at extremely low costs and does so with virtually no impact to the environment. Power can be extracted 24 hrs a day 365 days a year because rivers, tides, and currents never stop. In essence, this invention offers “baseline” energy and unlike solar and wind no back-up fossil fuel power plant or nuclear power plant is required.

This invention essentially consists of one or more paddlewheels, one or more generators installed on the paddlewheel itself versus attached to a shaft extending from the paddlewheel, one or more slip rings or other means by which to make an electrical connection through a rotating component, and mooring lines which keep the device in position as well as optimally align it toward moving water. In a preferred embodiment a subsea cable delivers the electrical energy from the generator to shore.

### BRIEF DESCRIPTION OF THE SEVERAL VIEWS OF THE DRAWINGS

FIG. 1 is front view of the device.

FIG. 2 is a left elevation view of the device.

FIG. 3 is right elevation view of the device.

FIG. 4 is a right elevation view of the device in water to show the components above water surface.

FIG. 5 is an elevation view of the rotor and stator components of a generator.

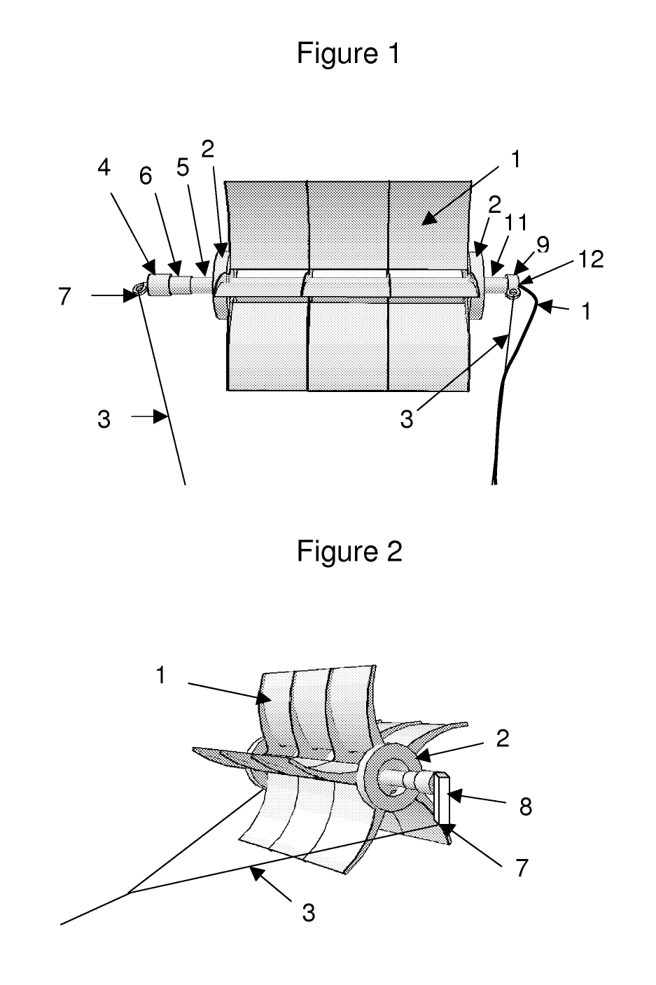

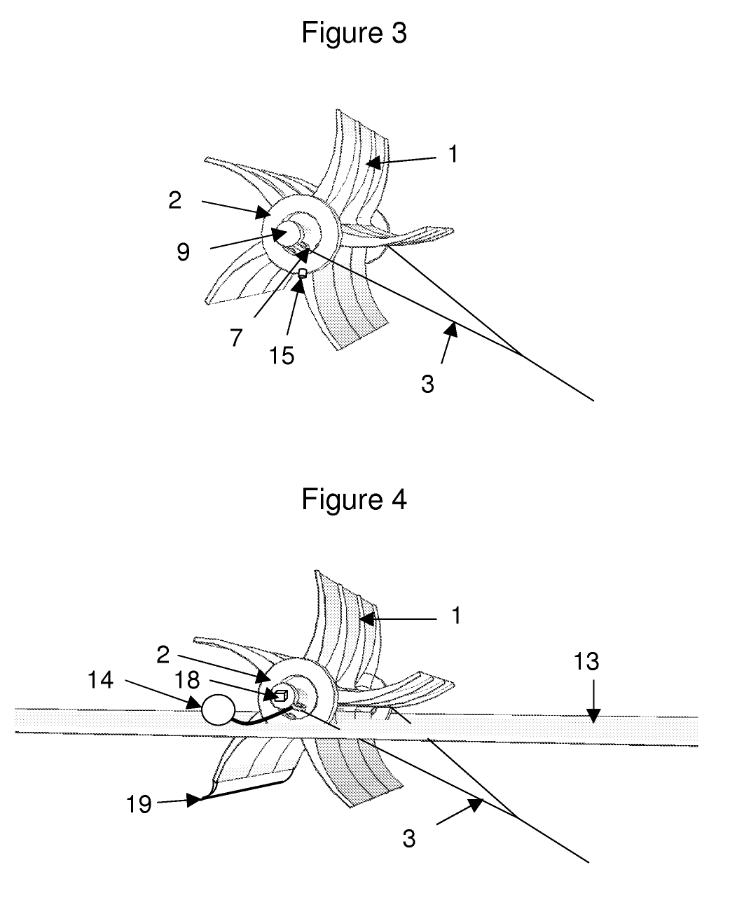

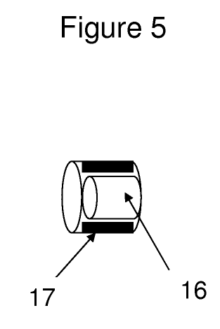

### DESCRIPTION OF THE PREFERRED EMBODIMENT

The four figures illustrate an embodiment of this invention. The invention can be designed and scaled for any water depth, current width, water speed, power output requirement, etc. A preferred embodiment would likely be constructed of painted steel, sailboat sail, or other suitable marine grade materials. Components of the device include one or more paddlewheels (1) which rotate when moving water is near the device. Buoys (2) or additional paddlewheel volumes can help elevate the device so that a paddlewheel shaft (5) and critical components are not submerged. An elevated version is best shown in FIG. 4. Mooring lines (3) hold the device in position and also help to optimally and automatically align the device toward flowing water. In one embodiment a gearbox (4) is mounted to or installed inside the paddlewheel shaft (5). The gearbox increases the rotational speed of the shaft turning the generator (6). Although this may sound counter-intuitive, the gearbox shaft is rotated by a connection (7) to one of the fixed mooring lines. In essence, instead of the gearbox shaft being directly rotated which is the case with most inventions the gearbox frame is rotated relative to the gearbox shaft which cause the gearbox shaft to rotate. The generator can internally consist of rotor (16) and stator (17) components. If necessary, a structural torque arm (8) can extend from the gearbox to the mooring line. The gearbox frame rotates relative to the gearbox shaft, which causes the gearbox gears to spin, which in turn causes the gearbox output shaft to rotate with higher speed, which in turn rotates the generator at high speeds. At the opposite end of the paddlewheel a bearing, bushing, or swivel (9) can allow the paddlewheel to rotate relative to a mooring line (3). An electrical cable (10) starting from the generator can connect to a slip ring preferably located inside the paddlewheel shaft and near the opposite end of the device (11) before passing through a hole at the end (12) and eventually running down the other mooring line. At the location of the hole there will likely be a watertight grommet or seal. The slip ring is to ensure that the electrical cable does not twist as the generator and paddlewheel rotate continuously. This slip ring can be any means by which to make an electrical connection through a rotating component. At ocean bottom or riverbed the mooring lines may be connected to clump weights, suction piles, or any form of anchor. The anchoring system can be any means by which to secure the device in position. The device can be secured to ocean bottom, a boat, or any other object that remains relatively fixed in relation to the moving water. A mooring line running down through deep water depths may have buoys intermittently attached to it to help offset the line's self weight. In a preferred embodiment, the generator would be a large diameter annular generator so that a minimal gearbox ratios or possibly no gearbox at all would be necessary. The gearbox can be any form of transmission which includes but is not limited to belts and pulleys, chain drives, etc. Buoys (2) or other floatation volumes can enable critical components to be elevated above water surface (13) away from corrosive water contact. This elevated level also enables critical components to be more readily accessible for maintenance and repair via repairman standing on a nearby barge, on dockside, etc.

It is important to note that the paddles rotate fairly slowly which provides considerable safety to all marine animals. The power of this device is primarily due to the scalability and enormous area of the paddle surface vs. rotational speed of the device. Simplicity and scalability are the keys to lowest energy cost. As mentioned previously, marine turbine blades have low drag and high rotational speeds. This device has high drag/torque and low rotational speeds. As a result, this device can be scaled much larger and arrays of devices are not necessary. Fish, dolphins, manatees, whales, and other marine life swimming by this invention are likely moving at similar speeds as the flowing water itself and likely in the same direction as the moving water. Thus, these animals will likely do little more than just brush against a paddle of the paddlewheel. Nevertheless, the paddles rotate slowly and the tips/edges of paddles on the paddle wheel can consist of soft flexible materials (19) to ensure any contact with marine animals is a soft contact and cannot injure the animals. Unlike other marine energy systems, it is not the rotational speed of the paddlewheel that generates enormous amounts of energy, but the size and force of the water behind the paddles that result in the staggering amounts of energy.

This device uses paddles because unlike marine turbine blades paddles can have far more surface area for more energy extraction and they can more easily be built strong enough to withstand impacts, wave forces, etc. Hydrodynamic efficiency is not really a concern with paddles. The incredible efficiency of this device is not achieved via the use of paddles since paddles are known to be less efficient than a single set of turbine blades. The incredible efficiency and cost-effectiveness of this invention is a result of the shear size, scale, yet very few components in comparison with arrays of traditional marine turbines. Maintenance costs associated with hundreds of components is what makes an array of devices costly to operate and drives up the cost/kwh.

This invention can have an additional rope and spherical buoy (14) that get utilized at times of exceptionally severe storms. The middle portion of the paddlewheel shaft, buoys, and/or other paddlewheel volumes can be flooded via valves (15) which will cause the entire device to become slightly negatively buoyant. In essence, the device will just barely sink. This will allow the device to hang from the cable and spherical buoy (14) until severe storms pass. Alternatively, the end of a paddlewheel shaft can remain filled with air to allow the device to remain just slightly positively buoyant. After a severe storm has passed the flooded spaces can be pumped with air, water will be forced out of them, and the device will again float and resume normal operations.

In one preferred embodiment, lights are installed on the device to notify ships of its location at night and in fog. Nevertheless, this invention would most likely be installed far from shipping lanes. At five to ten miles out, this invention would not likely be visible from shore. All critical components are enclosed and protected from the harsh wet environment. A subsea cable (10) could bring the electrical power from generator to shore. Many of these devices could be installed where only a single cable brings all of the power to shore. Alternatively, batteries, super capacitors, compressed air tanks, or other energy storage methods could be utilized. The paddlewheel rotational speed and torque can be properly balanced to maximize power output. Thus, a means by which to either electrically control the load placed on the generator, load balance, or otherwise control the speed of the paddlewheel can be included to maximum power production. Said another way, a means by which to control the speed of the paddlewheel (18) can be provided so that it does not produce too much speed and too little torque nor too much torque but too slow of speed. Slip clutches can be added to ensure that no dynamic forces could ever overload the gears.

In a preferred embodiment, the paddlewheel shaft encloses power processing equipment and transformers to boost power voltage prior to sending it down the subsea cable. While one section of the paddlewheel shaft may be floodable, the other which would enclose power processing equipment could be climate controlled and de-humidified to create an ideal environment for any electrical equipment.

What is claimed is:

1. A device for transforming the energy of moving water into useable energy comprising one or more paddlewheels, one or more generators, and one or more mooring lines whereby one or more rotors rotate with the paddlewheel and one or more stators do not rotate due to their connection to one or more mooring lines, and a means by which to hold one or more mooring lines to seabed or riverbed.

2. The device of claim 1 with a means by which to either control electrical loads or otherwise control the rotational speed of the paddlewheel which results in improved if not optimized power output from the device.

3. The device of claim 1 whereby one or more transmissions or gearboxes are included which results in the improved rotational speed of one or more generators.

4. The device of claim 1 whereby one or more paddles of one or more paddlewheels have flexible or soft tips.

5. The device of claim 1 whereby one or more paddles can pivot, or partially pivot, to create increased cross-sectional area against the direction of water flow when the direction of flow relative to one or more paddles is more useful.

6. The device of claim 1 whereby navigational warning equipment is included on or near the device which alerts persons to the location of the device.

7. The device of claim 1 with a means by which to temporarily submerge the device.

8. A device for transforming the energy of moving water into useable energy comprising one or more paddlewheels, one or more generators, and one or more mooring lines whereby one or more rotors rotate with the paddlewheel and one or more stators do not rotate due to their connection to one or more mooring lines, a means by which to hold one or more mooring lines to seabed or riverbed, and a means by which to either control electrical loads or otherwise control the rotational speed of the paddlewheel which results in improved if not optimized power output from the device.

9. The device of claim 8 whereby one or more transmissions or gearboxes are included which results in improved rotational speed of one or more generators.

10. The device of claim 8 whereby one or more paddles of one or more paddlewheels have flexible or soft tips.

11. The device of claim 8 whereby one or more paddles can pivot, or partially pivot, to create increased cross-sectional area against the direction of water flow when the direction of flow relative to one or more paddles is more useful.

12. The device of claim 8 whereby navigational warning equipment is included on or near the device which alerts persons to the location of the device.

13. The device of claim 8 with a means by which to temporarily submerge the device.

14. A device for transforming the energy of moving water into useable energy comprising one or more paddlewheels, one or more gearboxes, one or more generators, one or more torque arms, and one or more mooring lines whereby one or more rotors rotate with the paddlewheel and one or more stators do not rotate due to their connection to one or more mooring lines, a means by which to hold one or more mooring lines to seabed or riverbed, and a means by which to either control electrical loads or otherwise control the rotational speed of the paddlewheel which results in improved if not optimized power output from the device.

15. The device of claim 14 whereby one or more paddles of one or more paddlewheels have flexible or soft tips.

16. The device of claim 14 whereby one or more paddles can pivot, or partially pivot, to create increased cross-sectional area against the direction of water flow when the direction of flow relative to one or more paddles is more useful.

17. The device of claim 14 whereby navigational warning equipment is included on or near the device which alerts persons to the location of the device.

18. The device of claim 14 with a means by which to temporarily submerge the device.
